(19) United States
(12) Patent Application Publication
(10) Pub. No.: US 2026/0274473 A1
(43) Pub. Date: Sep. 17, 2026

(54) APPARATUS AND METHOD FOR AUTOMATICALLY FILLING AND CAPPING CONTAINERS

(71) Applicant: I.M.A. INDUSTRIA MACCHINE AUTOMATICHE S.P.A., OZZANO DELL'EMILIA (BO) (IT)

(72) Inventors: Claudio TREBBI, OZZANO DELL'EMILIA (BO) (IT); Alessandro FARNE', OZZANO DELL'EMILIA (BO) (IT); Gianluca ZAULI, OZZANO DELL'EMILIA (BO) (IT); Daniele RICCIARDI, OZZANO DELL'EMILIA (BO) (IT); Filippo MEARINI, OZZANO DELL'EMILIA (BO) (IT); Sergio MANERA, OZZANO DELL'EMILIA (BO) (IT); Annalisa MALFATTO, OZZANO DELL'EMILIA (BO) (IT)

(21) Appl. No.: 19/143,599

(22) PCT Filed: Dec. 14, 2023
(86) PCT No.: PCT/IT2023/050282

§ 371 Date: Jun. 26, 2025

(30) Foreign Application Priority Data
Dec. 28, 2022 (IT) 102022000026904

(51) Int. Cl. B65B 7/28; B65B 3/04

(52) U.S. Cl. CPC B65B 7/2835; B65B 3/04

(57) ABSTRACT

Apparatus (10; 10′) for automatically filling and capping containers (C), comprising a driving surface (17, 17′, 17′'), a first transport member (21) which is movable on the first driving surface (17) in a contactless manner by means of magnetic interaction between a first rotor magnetic field of said first transport member (21) and a first stator magnetic fields generated by first electric means associated to said first driving surface (17), so that a selective energization of said first electric means allows a movement of the first transport member (21) relative to the first driving surface (17). Each transport member (21) is configured to support at least one closure element (T) and at least one container (C) so as to transport them in a filling station (15) and in a capping station (16).

### FIELD OF THE INVENTION

The present invention concerns an apparatus and method for automatically filling and capping small-sized containers, for example vials, phials or flasks, which can be filled with fluid, solid, powder, or gel products, and closed with respective closure elements, such as stoppers, crimp caps, ring nut caps or suchlike. By way of example, the apparatus can be used in the pharmaceutical, cosmetic, health, chemical and/or food fields.

### BACKGROUND OF THE INVENTION

In the industrial sector of packaging chemical, cosmetic and/or pharmaceutical products, different apparatuses and methods are known for automatically packaging containers, for example vials or flasks, which are moved to and from one or more work stations in order to be filled and then closed.

In this sector, there is an increasing demand for apparatuses that can package such containers in an environment that is safe and aseptic, ecologically sustainable and silent, without generating pollutants and agents capable of contaminating the container and/or the product contained therein, and in which human intervention to carry out the usual operations of the sector is reduced to a minimum, if not even eliminated.

In particular, at least one apparatus is known from US 2018/0229866 A1 in which the movement of the containers occurs by using movers driven with an electromagnetic type drive, in contactless mode, without any constraint in direction or fixed path, and without generation of particulate caused by rubbing, for example by using the technology known as “planar motors”.

Such planar motors comprise magnetic means which cooperate with electric energizing means operatively associated with them and configured to selectively generate one or more magnetic fields to influence the magnetic means. In particular, these magnetic means are mounted on the mover and the electric energizing means, such as coils, are incorporated within a fixed driving surface on which the mover can slide without contact thanks to the controlled electromagnetic field that is generated between the magnetic means and the electric energizing means. Moreover, the planar motors are very versatile, since they allow to follow both rectilinear as well as curved trajectories and paths, with respect to the driving surface, by suitably commanding the electric energizing means.

In the known apparatus as above, the containers are fed at a feeding station and placed one at a time on a respective mover. Then, the movers transport the containers toward a filling station and a closure station.

At the closure station there is one receptacle in which the closure elements are stored and are suitably provided in separated form via a feeder.

In the closure station, the planar motor moves the container along the feeder with a preferably continuous towing movement so that the closure element comes to rest on the container opening.

It is evident that the closure of the container through this towing movement renders this closing step slow and not reliable because it is hard precisely centering the closure element with respect to the container, which is an operation that due to the towing movement must be done gradually and slowly.

Alternatively, the feeding devices of other solution known in the art can be provided with vibrating means which, by vibrating, make the closure elements advance up to a pick-up position, to then be picked up one at a time in order to close a corresponding container.

The use of such vibrating means has, however, the disadvantage that, in order to make the closure elements advance, small amounts of particles and/or dusts are also transported and lifted which, in addition to being dispersed in the surrounding work environment, can fall back inside the containers, contaminating their content.

There is therefore the need to perfect an apparatus for automatically packaging containers that can overcome at least one of the disadvantages of the state of the art

To do this, it is necessary to solve the technical problem of creating an apparatus in which the filling and capping of the containers is carried out without the risk of dispersing in the work environment, even in minimum quantities, particles and/or dusts that may contaminate the contents present in the containers themselves.

In particular, one purpose of the present invention is to provide an apparatus for automatically filling and capping containers that is safe and guarantees hygiene and cleanliness standards that make it suitable to be also used in machines for the chemical, cosmetic and/or pharmaceutical sectors, which normally require an aseptic and contaminant-free work environment.

Another purpose of the present invention is to provide an apparatus and develop a method for automatically filling and capping containers that are reliable and highly efficient.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, an apparatus according to the present invention for automatically packaging containers comprises a base plane provided with a reference surface with which there are associated electric energizing means configured to selectively generate one or more magnetic fields, and one or more transport members each provided with magnetic means configured to interact with the electric energizing means to cause the selective displacement of the respective transport member, along a work path, keeping it distanced from the reference surface.

In accordance with one aspect of the present invention, the apparatus comprises:
a first driving surface, a first transport member which is movable on the first driving surface in a contactless manner by means of magnetic interaction between a first rotor magnetic field of said first transport member and a first stator magnetic fields generated by first electric means associated to said first driving surface, so that a selective energization of said first electric means allows a movement of the first transport member relative to the first driving surface;
a second transport member which is movable on a second driving surface of a first feeding station in a contactless manner by means of magnetic interaction between a second rotor magnetic field of said second transport member and a second stator magnetic fields generated by second electric means associated to said second driving surface, so that a selective energization of said second electric means allows a movement of the second transport member relative to the second driving surface;
a third transport member which is movable on a third driving surface of a second feeding station in a contactless manner by means of magnetic interaction between a third rotor magnetic field of said third transport member and a third stator magnetic fields generated by third electric means associated to said third driving surface, so that a selective energization of said third electric means allows a movement of the third transport member relative to the third driving surface.

In accordance with one aspect of the present invention, said second transport member is provided with a second support member configured to hold a plurality of said containers, and a first pick and place device is provided that is configured to pick up one or more containers from the second support member at a first pick-up zone and place the picked-up container on said first transport member.

In accordance with one aspect of the present invention, said third transport member is provided with a third support member configured to hold a plurality of closure elements, and a second pick and place device is provided that is configured to pick up one or more closure elements from the third support member at a second pick-up zone and place the picked-up closure elements directly on the first transport member where the first pick and place device has placed one respective container to be filled and capped.

In accordance with one aspect of the present invention, the apparatus comprises a pick and place station, where said first and second pick and place devices are placed for distributing, in an orderly manner, at least one closure element and at least one container at a time on, or in, housing and support means of a respective transport member. In particular, in accordance with another aspect of the present invention, said first pick and place device is configured to pick up only one container at a time from the second transport member and said second pick and place device is configured to pick up only one closure element at a time from the third support member to respectively position them in a first and second house seating of the housing and support means.

Doing so achieves at least the advantage that the packaging of the containers is carried out without the risk of raising particles and/or dusts that can contaminate the product present in the containers.

In accordance with another aspect of the present invention, the apparatus comprises a filling station configured to fill said container placed on the first transport member and a capping station configured to close the filled container with the closing element which has been put on the same first transport member by said second pick and place device.

In accordance with another aspect of the present invention, the first and second feeding station are provided with feeding means having the function of feeding at least a first support member provided with a plurality of closure elements and at least a second support member provided with a plurality of containers.

Moreover, in the first and second feeding station there are two or more movement members, each provided with magnetic means configured to interact with the electric energizing means to cause the selective displacement of the respective movement member, along a feeding path, keeping it distanced from the reference surface.

In accordance with another aspect of the present invention, the filling station is provided with filling means comprising at least a first or second filling device associated with a respective first or second work segment of the work path. In particular, the at least first or second filling device is provided, respectively, with at least one delivery nozzle for delivering a certain quantity of product into a corresponding container, wherein the at least one delivery nozzle is axially aligned with the respective first or second work segment and placed above a respective first or second filling position of the transport members.

In accordance with another aspect of the present invention, the apparatus comprises a capping station is also provided with capping means placed in succession to the filling station along the work path and comprising at least a first or second capping device to close a respective already filled container, which is associated with the respective first or second work segment.

In accordance with another aspect of the present invention, the at least first or second capping device is provided with a respective first or second capping head configured to selectively and temporarily switch from a raised position to a lowered position in order to pick up a respective closure element, when the corresponding transport member is in a respective first or second pick-up position, and to close a respective container with the picked up closure element when the same transport member is in a respective first or second capping position.

In accordance with another aspect of the present invention, the apparatus comprises a first detection member configured to detect a possible positioning error of the containers placed on the first transport member by the first pick and place device.

In accordance with another aspect of the present invention, the apparatus comprises a second detection member configured to detect a possible positioning error of the closure elements placed on the first transport member by the second pick and place device.

In accordance with another aspect of the present invention, the apparatus comprises a central control unit configured to command the transport members to retrace a movement circuit of the work path in order to solve the positioning error, and to retrace a first return segment.

In this way, the apparatus has the advantage of being very versatile, allowing waste to be reduced; furthermore, the apparatus is more reliable because, if any operation has not been carried out correctly, it can be easily repeated by bringing the affected transport member back.

In accordance with another aspect of the present invention, said first transport member is provided with a first support member configured to hold one or more of said containers, preferably a single container.

In accordance with another aspect of the present invention, said first, second and third transport members are arranged on the respective first, second and third driving surfaces displaceably and/or rotatably in at least two degrees of freedom. In accordance with another aspect of the present invention, said work path is a closed path.

In accordance with another aspect of the present invention, at least said first and second driving surfaces form a base plate acting as a common driving surface.

In accordance with another aspect of the present invention, said third driving surface forms said base plate acting as a common driving surface with said first and second driving surfaces. The present invention also concerns a method for automatically filling and capping containers by means of an apparatus as defined in the aspects above.

In accordance with another aspect of the present invention, the method comprises a first feeding step, in which a first pick and place picks one container at a time from a second transport member holding a plurality of containers and place the picked-up container on a first transport member, and a second feeding step, in which a second pick and place picks one closure element at a time from a third transport member holding a plurality of closure elements and place the picked-up closure element either directly on the container which has been placed on the first transport member by the first pick and place device in the first feeding step or on said first transport member.

In accordance with another aspect of the present invention, the method comprises at least one filling step and at least one capping step in which, respectively in a filling station and in a capping station of the apparatus, the container is first filled and subsequently capped with the at least one closure element.

In accordance with another aspect of the present invention, in the first feeding step, the first pick-up member picks up one container at a time to position it in a respective first housing seating, while the latter is in a first distribution position and in the second feeding step the second pick-up member picks up one container at a time to position it in the respective second housing seating, while the latter has moved on the movement circuit of the work path and has reached a second distribution position.

In accordance with another aspect of the present invention, in the filling step the transport member advances until it reaches the proximity of the filling station to continue toward a first or second work segment and reach a first or a second filling position, respectively, in which a first or second filling device, by means of at least one respective delivery nozzle axially aligned with the corresponding first or second work segment, delivers a certain quantity of product into a corresponding container.

In accordance with another aspect of the present invention, in the capping step the transport member advances along the first or second work segment to reach a first or second pick-up position, respectively, in which a first or second capping device, lowering temporarily, picks up a corresponding closure element. Moreover, after the corresponding closure element has been picked up, the transport member advances from the first or second pick-up position to a first or second capping position, in which the first or second capping device, lowering again, closes the container with the corresponding closure element.

In accordance with another aspect of the present invention, after the feeding steps a first and second detection member detect a possible positioning error of the closure elements and/or of the containers placed on the respective transport members. If the positioning error is detected, the first transport members retrace the movement circuit in order to solve the positioning error.

After the capping step a third and fourth detection member detect a possible capping error on the containers. If the capping error is detected, the first transport members travel a first return segment and/or a second return segment in order to solve the capping error.

In addition, a vibration step can be provided before or after the capping step, in which the first transport members vibrate to agitate the already filled or, possibly, already capped containers, in order to substantially achieve a mixing and/or centrifugal effect on the product(s) present therein, or to keep particles of the product(s) present therein in suspension, thus preventing sedimentation phenomena.

### DESCRIPTION OF THE DRAWINGS

These and other aspects, characteristics and advantages of the present invention will become apparent from the following description of some embodiments, given as a non-restrictive example with reference to the attached drawings wherein: FIG. 1 is a top, schematized and simplified view of an apparatus according to an embodiment of the present invention for automatically filling and capping containers;

FIG. 1a is a view like that of FIG. 1, which shows some examples of possible operating paths of first transport members comprised in the apparatus according to FIG. 1;

FIGS. from 2 to 19 are top, detailed views, on an enlarged scale, of different operating stations comprised in the apparatus of FIG. 1, to depict examples of operating sequences that explain the steps of the method for filling and capping containers according to the present invention;

FIG. 20 is a top schematized and simplified view like of an apparatus according to another embodiment of the present invention for automatically filling and capping containers.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

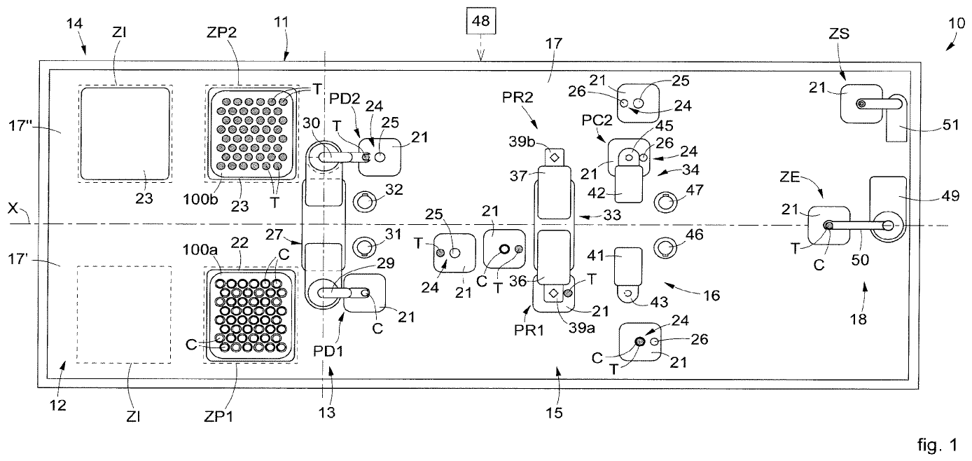

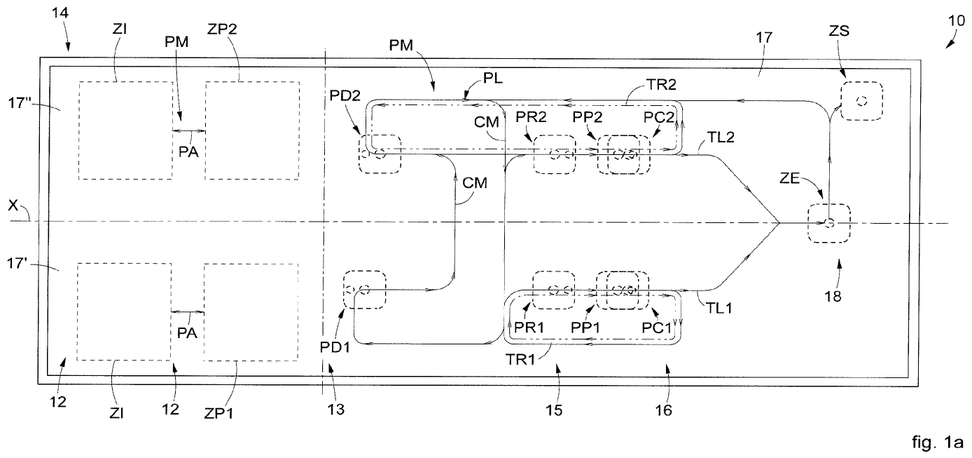

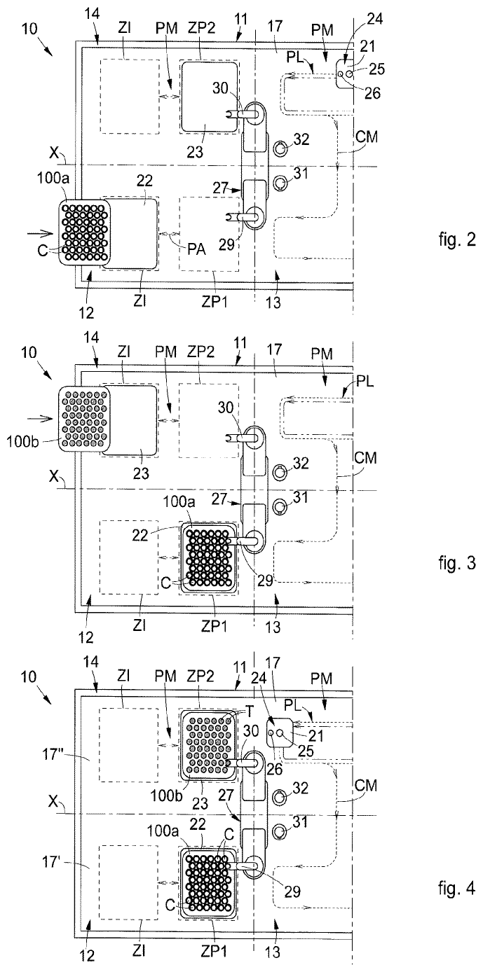

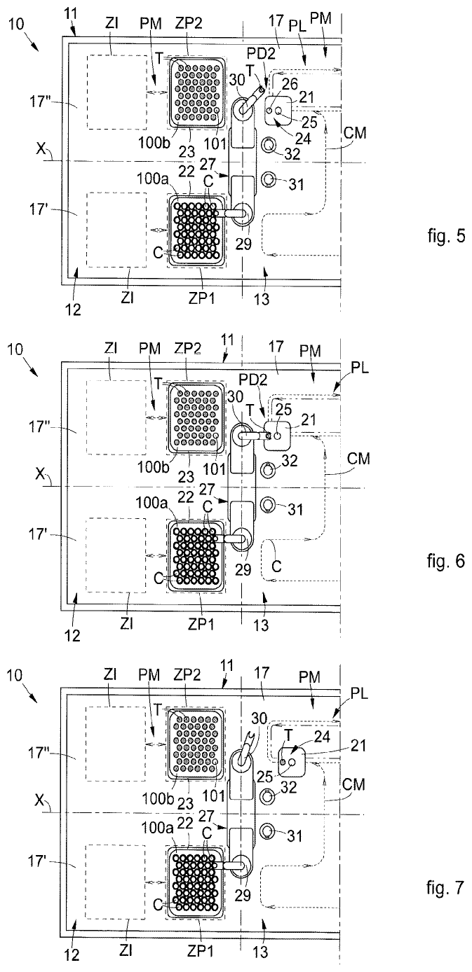

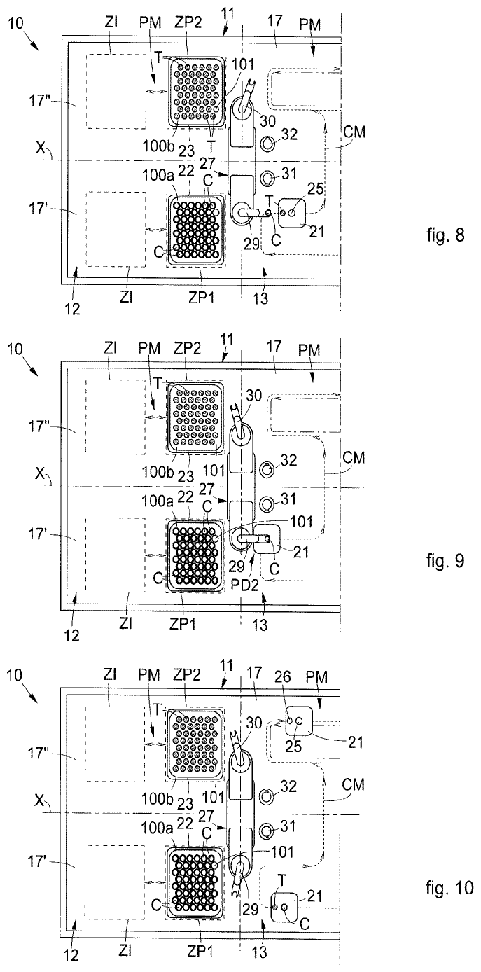

With reference to FIG. 1, an apparatus 10 according to the present invention is suitable and usable to automatically package containers C by moving them along a movement path PM, in particular to fill and cap them by means of respective closure elements T.

The containers C can be, without any limitation to generality, phials, vials, flasks, or other types of low mass containers, capable of containing fluid products, in particular liquids, solids, that is, in powder form, or gels.

The closure elements T can be, for example, caps, crimp caps, or ring nut caps. In the example given here, the closure elements T are preferably crimp caps.

For clarity of explanation, the following description refers both to FIG. 1, which represents an overall view of an example of the apparatus 10, and also to FIG. 1a, which shows examples of operating paths followed by some mobile parts of the apparatus during operation. It is clear that these mobile parts can follow other paths, therefore the paths shown in FIG. 1a are not intended as a limitation but are only shown by way of example.

We must clarify that FIG. 1a shows both the operating paths followed by the mobile parts of the apparatus 10 during its normal operation, indicated with continuous lines, and also the paths followed by the mobile parts of the apparatus 10 that return back with respect to the normal workflow, indicated with dashed lines, to again return into one or more operating stations in which the corresponding operations have to be repeated, in the event that they have not been carried out correctly, as will be described in more detail below.

The apparatus 10 comprises: a first feeding station 12 in which the containers C are fed and a second feeding station 14 in which the closure elements T are fed; a pick and place station 13 in which the containers C and the closure elements T are distributed in an orderly manner; a filling station 15, in which the containers C are filled with a certain product, a capping station 16 in which the containers C are capped with the respective closure elements T; and an extraction station 18 in which the containers C, already filled and closed, are prepared to be sent toward a subsequent distribution and labelling step.

The apparatus 10 comprises a first driving surface 17 below which there are associated electric energizing means, of a known type and not visible in the drawings, which are configured to selectively generate one or more magnetic fields, even locally distributed, along the movement path PM. For example, the electric energizing means comprise a plurality of electric coils or windings which, during use, are connected to an electric energy supply network having suitable electric voltage and current values.

The apparatus 10 also comprises a second driving surface 17′ extending in the first feeding station 12 and a third driving surface 17″ extending in the second feeding station 14.

In the example shown in the figures all the first, second and third driving surfaces 17, 17′, 17″ concurs to form a base plate 11 defining a common driving surface.

In other embodiments, not shown, the base plate 11 is defined by the first and second driving surfaces 17, 17′ only.

We must clarify that the movement path PM is determined, or influenced, by the placement of the electric energizing means.

The apparatus 10 comprises a plurality of first transport members 21 operatively associated with the first driving surface 17 and capable of moving with respect to the latter by means of the magnetic fields generated by the electric energizing means. In particular, the first transport members 21 are provided with magnetic means, such as for example permanent magnets of a known type and not shown in the drawings, which are configured to interact with the magnetic fields to cause the selective displacement of the first transport member 21. In this way, by suitably commanding the electric energizing means, the first transport members 21 can move independently from one another with respect to the first driving surface 17, remaining distanced from it by a certain distance, that is, without coming into contact with it, advantageously with several degrees of freedom. It should be noted that the aforementioned distance has to be such as to allow a correct interaction between the electric energizing means and the magnetic means.

In addition, at the first and second feeding station 12, 14 there are provided a second and a third transport member, respectively 22 and 23, which are also provided with magnetic means configured to interact with the electric energizing means in the same way as the transport members 21 and, therefore, having the same movement characteristics. Each of the second and third transport member 22, 23 comprises a base plate, for example quadrangular, provided with support means, not shown in the drawings, for supporting a respective support member, or tray, 100 in which a plurality of containers C and/or a plurality of closure elements T are able to be positioned. Specifically, each tray 100 is provided with a plurality of housing seatings in which the containers C and/or the closure elements T can be housed, as will be described in detail below.

Preferably, the transport members 21, 22 and 23 are made as mobile parts of magnetically driven “planar motors”, per se known in the state of the art.

In accordance with one aspect of the present invention, the first transport members 21 are configured to move, that is, to support and transport, at least one respective container C and at least one respective closure element T along a work path PL, depicted with a dashed line in the drawings, from the pick and place station 13 toward the filling station 15, the capping station 16 and then toward the extraction station 18. It should be noted that the work path PL defines a part of the movement path PM.

Each first transport member 21 is provided with housing and support means 24 for supporting and/or housing at least one closure element T and at least one container C. The housing and support means 24 comprise at least a first housing seating 25 for housing a corresponding container C and at least a second housing seating 26 for housing a corresponding closure element T. In addition, the housing and support means 24 can comprise suitable support members, not shown, which allow the plurality of containers C and/or closure elements T to be supported and kept in a stable position.

In the example given here, each first transport member 21 has a substantially square shape and the first housing seating 25 is made in a central and barycentric position of the first transport member 21, while the second housing seating 26 is made in an eccentric position and is aligned with the first housing seating 25.

According to possible embodiments, the second and third members 22, 23 have the function of moving the closure elements T and the containers C along a respective feeding path PA, from the first and second feeding station 12, 14 to the picked and place station 13. It should be noted that the feeding path PA defines another part of the movement path PM and in the embodiment shown here it is a substantially linear path along which the second and third transport members 22, 23 travel bidirectionally. It is clear that, in other embodiments, the feeding path could have other shapes in relation to the specific work requirements.

The first feeding station 12 can comprise feeding means for feeding the containers C and the second feeding station 14 can comprise respective feeding means for feeding the closure elements T. Specifically, the feeding means have the function of feeding, for example at an inlet zone ZI, at least a first tray 100a provided with a plurality of containers C and at least a second tray 100b provided with a plurality of closure elements T.

At the inlet zone ZI there can be a transfer device, substantially of a known type and not shown in the drawings, having the function of transferring and positioning the first and second tray 100a and 100b on the second and third transport members 22, 23 respectively. Specifically, the second and third transport members 22, 23 are programmed to transport the first and second tray 100a, 100b toward the pick and place station 13 along the feeding path PA, for example in order to position the first tray 100a at a first pick-up zone ZP1 and the second tray 100b at a second pick-up zone ZP2.

At the pick and place station 13 there is a pick-up and distribution device 27 having a first pick-up device 29 and a second pick-up device 30, for example configured as arms that are placed on opposite sides with respect to an axis of symmetry X of the apparatus 10, close to the first pick-up zone ZP1 and the second pick-up zone ZP2, respectively.

According to possible embodiments, the first and second pick-up device 29, 30 can be any type of known mechanical member whatsoever, or one which will be created in the future, capable of picking up one or more closure elements T at a time and one or more containers C at a time.

In particular, the first pick-up device 29 has the function of picking up one container C at a time from the first tray 100a to position it in the corresponding first housing seating 25 of the first transport member 21, while the latter is in a first distribution position PD1, and the second pick-up device 30 has the function of picking up one closure element T at a time from the second tray 100b to position it in the corresponding second housing seating 26 of the same transport member 21, while the latter is in a second distribution position PD2.

In accordance with possible embodiments of the present invention, the second and third transport members 22, 23 at the first and second pick-up zones ZP1, ZP2, are programmed to perform a plurality of movements suitable to make the closure elements T and the containers C present in the first and second tray 100a, 100b accessible to the first pick-up device 29 and to the second pick-up device 30, respectively.

In accordance with other possible embodiments of the present invention, the first pick-up device 29 and the second pick-up device 30 are sized and positioned in such a way as to be able to pick up the containers C and the closure elements T present in the first and in the second tray 100a, 100b, in order to place them in the same first transport member 21, considering that there may also be a relative movement between the second and third transport members 22, 23 and the first and second pick-up device 29 and 30.

At the pick and place station 13 there can also be a first and a second detection member 31 and 32 configured to detect a possible positioning error of the closure elements T and of the containers C on the first transport member 21, respectively. In the example given here, the detection members 31 and 32 mirror each other with respect to the axis of symmetry X and are oriented on opposite sides.

We must clarify that when the first transport member 21 is in the first distribution position PD1 and in the second distribution position PD2, respectively, the first housing seating 25 and the second housing seating 26, respectively, are placed exactly below a gripping end of the first pick-up device 29 and of the second pick-up device 30, respectively, for the correct insertion of the respective container C and the respective closure element T inside the respective first and second housing seating 25, 26.

At the pick and place station 13, the first transport members 21 move along a movement circuit CM (FIG. 1A) of the work path PL, which extends until it is against the filling station 15 and the capping station 16.

According to possible embodiments, it can be provided that the movement circuit CM is closed and that, when necessary, a first transport member 21 travels through it, in the event that the first and/or second detection member 31, 32 has detected a positioning error of the closure element T or of the container C, in order to allow the first transport member 21 to return to the first or second distribution position PD1, PD2.

The apparatus 10, at the filling station 15 comprise filling means 33 configured to fill the containers C, and at the capping station 16 comprise capping means 34 placed in succession to the filling means 33 along the work path PL and configured to sequentially cap the containers C by means of the corresponding closure elements T present on the same transport member 21.

The work path PL, at the filling station 15 and at the capping station 16, can comprise at least one work segment, in the specific example two work segments, namely a first and a second work segment TL1, TL2.

According to the possible embodiment shown in the drawings, as can be seen in FIG. 1A at the filling station 15 the work path PL is divided into a first and a second work segment TL1, TL2 which, in the example given here, are symmetrical to each other with respect to the axis of symmetry X and converge in proximity to the extraction station 18.

In this way, it is possible to perform the filling and closing operations of two different containers C in parallel, that is, on each work segment TL1 and TL2. Furthermore, for each container C these operations can be performed simultaneously, or they can be offset temporarily, for example by a few seconds, in order to prevent the two first transport members 21 from interfering with each other in the zone of convergence of the two work segments TL1 and TL2. Preferably, at inlet to the filling station 15 (FIGS. 12 and 13), each first transport member 21 is oriented in such a way that the respective housing seatings 25 and 26 are aligned with the corresponding work segment TL1, TL2, and that the second housing seating 26 is the first to be positioned toward the filling means 33.

The filling means 33 can comprise at least one filling device, for example a first and/or second filling device 36, 37 associated with the respective first and/or second work segment TL1, TL2.

According to the embodiment shown in the drawings, the filling means 33 (FIG. 1) comprise a first filling device 36 and a second filling device 37 placed mirroring each other and on opposite sides with respect to the axis of symmetry X.

The filling devices 36, 37 are provided with respective delivery nozzles 39a, 39b which have the function of delivering a certain quantity of product inside a corresponding container C, and which are axially aligned with a corresponding work segment TL1, TL2 (FIG. 1a) and placed above a first filling position PR1 and a second filling position PR2, respectively, of the first transport members 21. Specifically, when the first transport members 21 are in the first and/or second filling position PR1, PR2, the delivery nozzle 39a, 39b is coaxial with the corresponding first housing seating 25 to fill the container C placed therein.

In addition, the first transport members 21 are also configured to vibrate and agitate the already filled containers C to substantially obtain a mixing and/or centrifugal effect on the product(s) present therein, or to keep particles of the product(s) present therein in suspension, preventing sedimentation phenomena.

The capping means 34 can comprise at least one capping device, in particular two capping device in the example given here, named as a first and a second capping device 41, 42 associated with the respective first and/or second work segment TL1, TL2.

According to the embodiment shown in the drawings, the first and the second capping device 41 and 42 are substantially the same as each other, placed mirroring each other and on opposite sides with respect to the axis of symmetry X.

In the example given here, the first capping device 41 is operatively associated with the first work segment TL1 and is provided with a first closure head 43 configured to selectively and temporarily switch from a raised position to a lowered position in order to pick up a respective closure element T, when the first transport member 21 is in a first pick-up position PP1 (FIGS. 1a and 13), and to close a corresponding container C when the same first transport member 21 is in a first closure position PC1.

We must clarify that in the first pick-up position PP1 the first transport member 21 is positioned along the first work segment TL1 in such a way that the second housing seating 26, in which the closure element T is located, is aligned coaxially with the first closure head 43. In the first closure position PC1, on the other hand, the same first transport member 21 is positioned in such a way that the first housing seating 25, in which the already filled container C is located, is aligned coaxially with the first closure head 43.

In addition, in the example given here, the second closure device 42 (FIG. 1) is operatively associated with the second work segment TL2 and is provided with a second closure head 45 configured to selectively and temporarily switch from a raised position to a lowered position in order to pick up a respective closure element T, when the first transport member 21 is in a second pick-up position PP2 (FIGS. 1a and 15), and to close a corresponding container C when the same first transport member 21 is in a second closure position PC2.

We must clarify that in the second pick-up position PP2 the first transport member 21 is positioned along the second work segment TL2 in such a way that the second housing seating 26, in which the closure element T is located, is aligned coaxially with the second closure head 45. In the second closure position PC2, on the other hand, the same first transport member 21 is positioned in such a way that the first housing seating 25, in which the already filled container C is located, is aligned coaxially with the second closure head 45.

For example, each closure head 43, 45 (FIG. 1) can be provided with retaining means, not shown in the drawings, which allow to temporarily retain the closure element T in order to close the corresponding container C. According to possible embodiments, the retaining means comprise, or consist of, suction members that retain the corresponding closure element T through suction.

We must clarify that according to other possible embodiments the capping station 16 can comprise other closure means capable of performing the same function as the first and second capping device 41, 42, which can be of a known type or one which will be devised in the future.

After the capping station 16, there can also be a third and/or a fourth detection member 46, 47 configured to detect a possible closure error of the container C and, in particular, to detect the height of the container C closed by means of the corresponding closure element T.

By way of a non-limiting example, the detection members 31, 32, 46 and 47 can be optical sensors, photocells, video cameras or suchlike. In particular, the detection members 31, 32, 46 and 47 are operatively connected to a central control unit 48 (FIG. 1) which allows the movement of the first transport members 21 to be coordinated and commanded in relation to the various inputs received, in particular in the event that positioning and/or capping errors are present.

According to some embodiments, the work path PL (FIG. 1a) can also comprise a first return segment TR1 and/or a second return segment TR2 which are operatively connected to the first work segment TL1 and to the second work segment TL2, respectively.

Specifically, the first and the second return segment TR1 and TR2 have the function of allowing a first transport member 21 having a container C with a capping error detected by the third detection member 46, or by the fourth detection member 47, to return into the movement circuit CM in order to resume the first or second work segment TL1, TL2.

This is particularly advantageous since, by doing so, it is possible to solve the capping error by completing an incorrect capping or performing a new one, thus avoiding discarding the container C.

In the extraction station 18 (FIG. 1) there is at least one extraction device 49 which can be provided with an extraction arm 50 configured to extract the container C closed with the respective closure element T from the first transport member 21, in order to transfer it to another work zone, for example for its labelling. We wish to clarify that the extraction of the closed container C occurs at a corresponding extraction zone ZE (FIGS. 1 and 1a).

At the extraction station 18, the work path PL can comprise a return segment TR that allows an emptied first transport member 21 to return toward the movement circuit CM in order to reach the first distribution position PD1 again.

Moreover, according to possible embodiments, in the extraction station 18 there is also provided a reject zone ZS to accommodate a first transport member 21 provided with a container C that has a capping or positioning error that cannot be resolved, and therefore to be discarded. For example, at such reject zone ZS there is a removal device 51 configured to remove the container C to be discarded, so that the emptied first transport member 21 can return toward the movement circuit CM by means of the return segment TR.

The operation of the apparatus 10 described heretofore, which corresponds to a first embodiment of the method according to the present invention, comprises the following steps.

However, for clarity of explanation, first we wish to specify that here we have described the work steps relating to container C of a first tray 100a and to the closure elements T of a second tray 100b in a certain order, it being understood that this order is not intended as a limitation, and that all the other trays 100, the closure elements T and the containers C are then cyclically subjected to the same work. In addition, hereafter we have described a cycle of operations for packaging a container C considering only one first transport member 21, it being understood that during this cycle many other transport members 21 subjected to the same operations may also be present along the work path PL.

In a feeding step, the first tray 100a provided with a plurality of containers C and the second tray 100b provided with a plurality of closure elements T are fed at the inlet zone ZI respectively in the first and second feeding station 12, 14. Subsequently, the transfer device as above transfers and positions the first and second tray 100a, 100b respectively on the second and third transport member 22, 23. Then, the latter transport the first and second tray 100a and 100b into the first and second pick-up zones ZP1, ZP2, respectively (FIGS. from 2 to 4).

Subsequently, the pick-up and distribution device 27 picks up at least one closure element T and at least one container C at a time in order to distribute them and, therefore, position them on, or in, the housing and support means 24 of a same first transport member 21 that moves along the movement circuit CM (FIGS. from 4 to 10).

The first pick-up device 29 picks up a container C and places it in the first housing seating 25 of the first transport member 21, which is located in the first distribution position PD1. Before proceeding, the first detection member 31 checks that the container C has been correctly placed in the respective first housing seating 25 and possibly signals a positioning error to the central control unit 48 (FIGS. from 7 to 10).

The first transport member 21 advances along the movement circuit CM and stops at the second distribution position PD2. Then, the second pick-up member 30 picks up a closure element T and places it in the second housing seating 26 of the same first transport member 21 which is located in the second distribution position PD2. Before proceeding, the second detection member 32 checks that the closure element T has been correctly placed in the second housing seating 26 and possibly signals a positioning error to the central control unit 48 (FIGS. 4, 5 and 6).

If the first or the second detection member 31, 32 does not detect positioning errors, the first transport member 21 advances until it is in proximity to the filling and station 15, and then continues toward the first or second work segment TL1, TL2. The choice of directing the first transport member 21 toward the first or the second work segment TL1, TL2 is correlated to the possible presence of other first transport members 21 below the first or the second filling member 36, 37, as well as their number, so that the first transport member 21 is directed toward the work segment that is most free (FIG. 11).

Alternatively, if the first or the second detection member 31, 32 has detected a positioning error, the first transport member 21 moves along the movement circuit CM in order to reposition itself in the first or second distribution position PD1, PD2 so as to take the container C and/or the closure element T into the correct position in the respective first and second positioning seating 25, 26.

By way of example, we will now describe the filling and capping steps in the event that the first transport member 21 continues toward the first work segment TL1.

In a filling step, the first transport member 21 stops in the first filling position PR1 so that the container C is exactly below the corresponding delivery nozzle 39a of the first filling device 36, through which the container C is filled with a certain product (FIG. 12).

In a subsequent capping step, the first capping device 41 closes the container C, which is closed with the closure element T positioned on the same first transport member 21. Specifically, once the filling has been performed, the first transport member 21 advances to the first pick-up position PP1 so as to place the closure element T below the first closure head 43 (FIG. 13). Then, the first capping head 43 is temporarily lowered into the lowered position in order to take, or pick up, the closure element T, after which it returns into the raised position (FIG. 14). Subsequently, the first transport member 21 advances to the first capping position PC1 so as to take the already filled container C below the first capping head 43. Then, the first capping head 43 is again lowered into the lowered position in order to close the container C.

Once the container C has been closed, before the first transport member 21 heads toward the extraction station 18, the third detection member 46 checks that the capping of the container C has been carried out correctly, and possibly signals a capping error to the central control unit 48 (FIG. 15).

In the event of a capping error, the first transport member 21 does not advance toward the extraction station 18, but continues along the first return segment TR1 in order to first enter the movement circuit CM, or a part thereof, and then, once again, the first work segment TL1 in order to complete the capping of the container C, or carry out a new one.

Once the capping error has been solved, the first transport member 21 heads toward the extraction station 18. If the capping or positioning error cannot be solved, the first transport member 21 in any case advances toward the extraction station 18 to then be discarded.

It is clear that in the event that the first transport member 21 continues toward the second work segment TL2, the execution modes of the filling and capping steps remain the same, but considering the second filling device 37 with the respective delivery nozzle 39b, the second capping device 42 with the respective second capping head 45, the fourth detection member 47 and the second return segment TR2 (FIGS. from 13 to 17), and with reference to the second filling position PR2 (FIG. 14), the second pick-up position PP2 (FIG. 15) and the second closure position PC2 (FIG. 16).

Furthermore, we must clarify that the capping of the containers C by means of the closure elements T can take place by means of crimping or other suitable techniques or methods.

In addition, before or after the capping step, a vibration step can be provided in which the first transport members 21 vibrate in order to agitate the containers C already filled or, possibly, already closed, to substantially obtain a mixing and/or centrifugal effect on the product(s) present therein, or to keep particles of the product(s) present therein in suspension, thus preventing sedimentation phenomena.

Once the extraction station 18 has been reached, an extraction step then begins at the extraction zone ZE (FIG. 17), in which the extraction device 49, by means of the extraction arm 50, extracts the container C capped with the respective closure element T in order to transfer it toward another work zone, for example a labelling zone (FIG. 18).

Once the capped container C has been extracted, the emptied first transport member 21 advances along the return segment TR and heads toward the movement circuit CM, and in particular toward the first distribution zone PD1, in order to receive another container C and start a new cycle of operations.

In the event that the container C has a capping or positioning error which cannot be solved, instead of performing the extraction step at the extraction zone ZE, the first transport member 21 advances along a first part of the return segment TR in order to head directly toward the reject zone ZS (FIG. 19). A discarding step then begins, in which the removal device 51 removes and discards the container C, emptying the first transport member 21 which can then head toward the movement circuit CM, and in particular toward the first distribution zone PD1 in order to start a new cycle of operations.

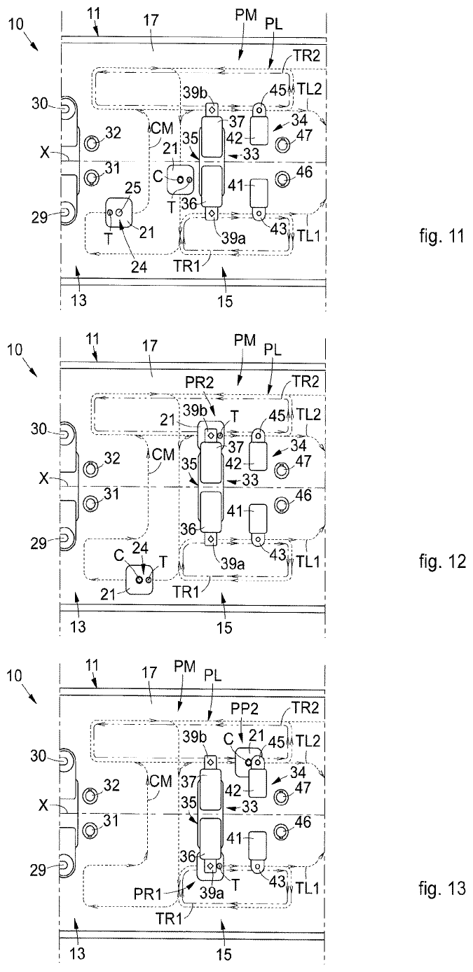

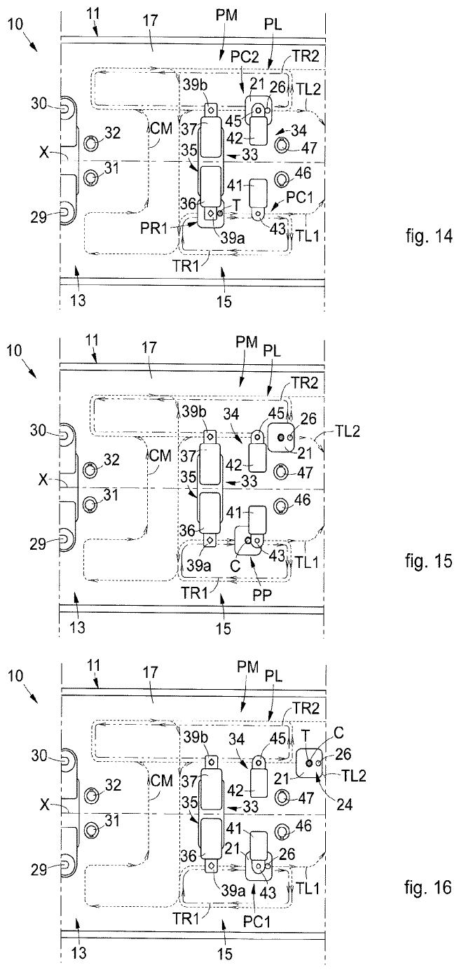

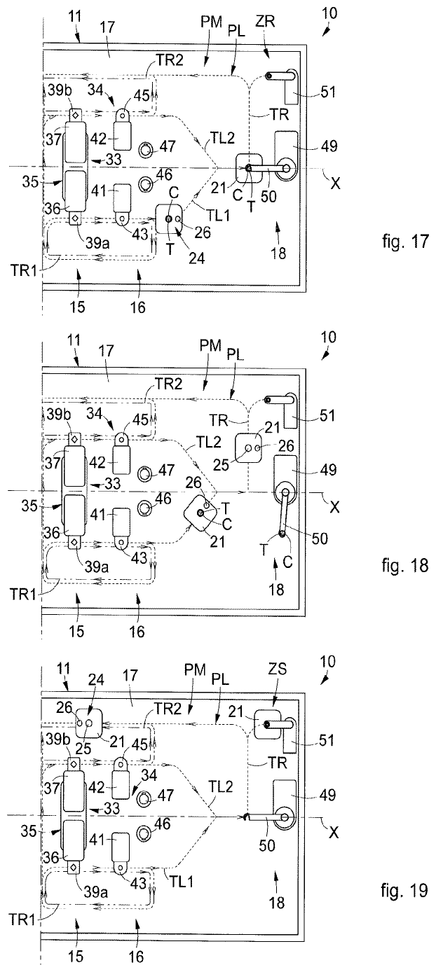

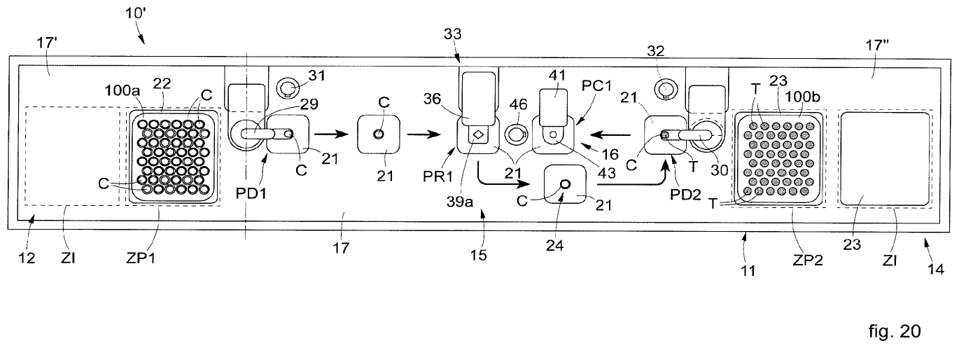

FIG. 20 shown a different embodiment of the apparatus according to the invention, that is indicated in this case with reference number 10′, which differs from the embodiment of the apparatus 10 described above with reference to FIG. 1 for the position of the second feeding station 14 and of the second pick-up zone ZP2, which are placed closer to the capping station 16.

Their different positioning in the apparatus 10′ results in a different layout of the apparatus and in a different operation of the same.

According to this embodiment of the invention, in the first distribution position PD1 the first pick-up device 29 picks up one container C at a time from the first tray 100a to position it in the corresponding first housing seating 25 of the first transport member 21. Afterwards the first transport member 21 is moved to reach a first filling position PR1 in the filling station 15, where the filling means 33, in particular the first filling device 36, fills the container C previously placed on the first transport member 21.

Subsequently the first transport member 21 carrying the filled container C reaches the second distribution position PD2, where the second pick-up device 30 picks up one closure element T at a time from the second tray 100b to position it directly on the filled container C present on the first transport member 21. It is noted that the closure element T is placed on the upper opening of the container C resting on it without being inserted inside it. Therefore, after this step the container isn't stilled capped. Then, the first transport member 21 reaches the first capping position PC1 in the capping station 16, where the first capping head 43 is lowered so as to cap the container C with the closure element T previously arranged resting on the upper opening of the container.

After capping the first transport member 21 moves toward the extraction zone ZE and possibly to the reject zone ZS as described above with reference to the embodiment of FIG. 1.

In this embodiment the housing and support means 24 comprises only the first housing seating 25 for housing and supporting one container C. The second housing seating 26 for housing and seating the closure element T may not be present in this embodiment since the closure element T is placed directly on the container C, without being previously and temporary placed in a dedicated seating of the first transport member 21.

According to a variant, the apparatus 10′ can comprise two filling devices, as for example the first filling device 36 and the second filling device 37 described with reference to the embodiment of FIG. 1, and two capping devices, as for example the first capping device 41 and the second capping device 42 described with reference to the embodiment of FIG. 1.

It is clear that modifications and/or additions of parts may be made to the apparatus 10, 10′ and to the method as described heretofore, without departing from the field and scope of the present invention, as defined by the claims.

For example, according to other embodiments of the present invention, not shown in the drawings, the apparatus 10, 10′ can be provided with weighing means for weighing the containers C before and after the corresponding filling with the aforementioned product P.

According to other embodiments, not shown in the drawings, in the event the delivery nozzles 39a, 39b can be replaced in relation to the type of container C to be filled, the apparatus 10, 10′ at the filling and closing station 15, can be provided with suitable gripping and movement devices provided, for example, with mechanical arms, which are configured to cooperate with each other and with the corresponding delivery nozzles 39a, 39b to replace them.

According to other embodiments, the apparatus 10, 10′ can have a different layout from the one shown, which is substantially symmetrical with respect to the axis of symmetry X, for example having only the upper part, or the lower part, compared to what shown in FIGS. 1 and 1a. In this case, the various operating means referred to previously, for example the filling means 33 and the capping means 34, can comprise only some of the above-mentioned devices, for example only the first filling device 36, and therefore the delivery nozzle 39a, and the first capping device 41, that is, the first capping head 43, or only the second filling device 37, and therefore the delivery nozzle 39b, and the second capping device 42, that is, the second capping head 45. In the first case, the first transport members 21 will follow the first work segment TL1 and possibly the first return segment TR1, passing through the positions placed on these segments, while in the second case the first transport members 21 will follow the second work segment TL2 and possibly the second return segment TR2, passing through the positions placed on these respective segments.

It is also clear that, although the present invention has been described with reference to some specific examples, a person of skill in the art will be able to achieve other equivalent forms of an apparatus and method for automatically filling and capping containers, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Apparatus for automatically filling and capping containers comprising a first driving surface, a first transport member which is movable on the first driving surface in a contactless manner by means of magnetic interaction between a first rotor magnetic field of said first transport member and a first stator magnetic fields generated by first electric means associated to said first driving surface, so that a selective energization of said first electric means allows a movement of the first transport member relative to the first driving surface, a second transport member which is movable on a second driving surface of a first feeding station in a contactless manner by means of magnetic interaction between a second rotor magnetic field of said second transport member and a second stator magnetic fields generated by second electric means associated to said second driving surface, so that a selective energization of said second electric means allows a movement of the second transport member relative to the second driving surface, said second transport member being provided with a second support member configure to hold a plurality of said containers, and a first pick and place device is provided that is configured to pick up one or more containers from the second support member at a first pick-up zone and place the picked-up container on said first transport member, said apparatus being characterized by further comprising a third transport member which is movable on a third driving surface of a second feeding station in a contactless manner by means of magnetic interaction between a third rotor magnetic field of said third transport member and a third stator magnetic fields generated by third electric means associated to said third driving surface, so that a selective energization of said third electric means allows a movement of the third transport member relative to the third driving surface, said third transport member being provided with a third support member configured to hold a plurality of closure elements, and a second pick and place device is provided that is configured to pick up one or more closure elements from the third support member at a second pick-up zone and place the picked-up closure elements directly on the container which has been placed on the first transport member by the first pick and place device and filled with liquid or on said first transport member.

2. Apparatus as in claim 1, further comprising a filling station configured to fill said container placed on the first transport member, and a capping station configured to cap the filled container with the closing element which has been put on the container after filling or on the same first transport member by said second pick and place device.

3. Apparatus as in claim 1, said first pick and place device is configured to pick up only one container at a time from the second transport member and said second pick and place device is configured to pick up only one closure element at a time from the third support member

4. Apparatus as in claim 1, further comprising a first detection member configured to detect a possible positioning error of said container which has been placed on the first transport member by the first pick and place device.

5. Apparatus as in claim 1. further comprising a second detection member configured to detect a possible positioning error of said closure elements which has been placed on the first transport member by the second pick and place device.

6. Apparatus as in any of the claim 2, further comprising a third and/or a fourth detection member placed after said capping station and configured to detect a possible capping error of said closure elements inserted into said container.

7. Apparatus as in claim 5, further comprising:
a first detection member configured to detect a possible positioning error of said container which has been placed on the first transport member by the first pick and place device; and
a central control unit connected to said first and second detection members and configured to command said first transport member to retrace a closed circuit of a work path in order to solve said positioning error.

8. Apparatus as in claim 7,
further comprising a third and/or a fourth detection member placed after said capping station and configured to detect a possible capping error of said closure elements inserted into said container, and
wherein said central control unit is connected to said third and fourth detection members and configured to command said first transport member to retrace a first or a second closed return segment of a work path in order to solve said capping error.

9. Apparatus as in claim 1, wherein said first transport member is provided with a first support member configured to hold one or more of said containers.

10. Apparatus as in claim 1, wherein said first, second and third transport members are arranged on the respective first, second and third driving surfaces displaceably and/or rotatably in at least two degrees of freedom.

11. Apparatus as in claim 1, wherein said first transport member follows a closed work path.

12. Apparatus as in claim 1, wherein at least said first and second driving surfaces form a base plate defining a common driving surface.

13. Apparatus as in claim 12, wherein said third driving surface forms said base plate with said first and second driving surfaces.

14. Method for automatically filling and capping containers by means of an apparatus according to claim 1, wherein said method comprises:
a first feeding step, in which a first pick and place device picks one container at a time from a second transport member holding a plurality of containers and place the picked-up container on a first transport member,
a second feeding step, in which a second pick and place device picks one closure element at a time from a third transport member holding a plurality of closure elements and place the picked-up closure element either directly on the container which has been placed on the first transport member by the first pick and place device in the first feeding step, or on said first transport member,
a filling step in which said container is filled in a filling station,
a capping step in a capping station, in which said closure element is inserted in the container filled in the filling station.

15. Method as in claim 14, wherein, after said first and second feeding steps and/or after said capping step, a central control unit command said first transport member to retrace a closed return path of a work path in order to solve a positioning or a capping error detected by detection members either after said first and/or second feeding step or after said capping step.
